(19) United States
(12) Patent Application Publication
(10) Pub. No.: US 2018/0359646 A1
(43) Pub. Date: Dec. 13, 2018

(54) COMMUNICATION APPARATUS AND COMMUNICATION METHOD

(71) Applicant: SHARP KABUSHIKI KAISHA, Sakai City, Osaka (JP)

(72) Inventors: HIROMICHI TOMEBA, Sakai City (JP); HIDEO NAMBA, Sakai City (JP); YASUHIRO HAMAGUCHI, Sakai City (JP)

(21) Appl. No.: 15/779,647

(22) PCT Filed: Sep. 15, 2016
(86) PCT No.: PCT/JP2016/077216

§ 371 Date: May 29, 2018

(30) Foreign Application Priority Data
Dec. 2, 2015 (JP) 2015-235636

(51) Int. Cl. H04W 16/28; H04L 5/00; H04B 7/04

(52) U.S. Cl. CPC H04W 16/28; H04B 7/04; H04L 5/0048

(57) ABSTRACT

To provide a communication apparatus and a communication method capable of simultaneously directing main beams to reception stations and transmission stations the numbers of which exceed the number N of RF systems provided to the communication apparatus itself. The communication apparatus according to the present invention includes a transmission unit configured to generate non-orthogonal multiplexed signals including downlink signals addressed to multiple terminal apparatuses, an antenna capable of forming an antenna directivity pattern including multiple main beams, and a transmission beam control unit configured to generate a signal controlling the antenna directivity pattern, wherein the non-orthogonal multiplexed signals are simultaneously transmitted by use of the multiple main beams, and the number of main beams included in the antenna directivity pattern is more than the number of RF systems of the antenna.

### TECHNICAL FIELD

The present invention relates to a communication apparatus and a communication method.

### BACKGROUND ART

In a communication system such as Long Term Evolution (LTE) or LTE-Advanced (LTE-A) standardized by the Third Generation Partnership Project (3GPP), the communication area can be widened by taking a cellular configuration in which areas covered by base station apparatuses (base stations, transmission stations, transmission points, downlink transmission devices, uplink reception devices, a group of transmit antennas, a group of transmit antenna ports, component carriers, eNodeB, access points, AP) or transmission stations equivalent to the base station apparatuses are arranged in the form of multiple cells (Cells) being linked together. In such a cellular configuration, frequency efficiency can be improved by using the same frequency among neighboring cells or sectors.

In recent years, to increase system capacity or enhance communication opportunity, a technique in which multiple terminal apparatuses are non-orthogonally multiplexed to perform transmission by allocating a resource with the same time, frequency, and space is discussed. Inter-user interference is caused because multiple terminal apparatuses are non-orthogonally multiplexed to perform transmission by a base station apparatus. Therefore, the terminal apparatus needs to cancel the inter-user interference. Examples of a technique for cancelling the inter-user interference include Codeword level Interference Cancellation (CWIC) in which interference is removed after decoding interference signals. The above point is described in NPL 1.

Here, in the current communication systems including LTE, beamforming transmission and beamforming reception are adopted in which the transmission station and terminal apparatus (reception stations, reception points, downlink reception devices, uplink transmission devices, a group of receive antennas, a group of receive antenna ports, UE, stations, STA) adaptively change an antenna directivity pattern (antenna, pattern, beam pattern) for communication. For example, the transmission station can direct a main beam of the beam pattern to the reception station to expand a communication area.

Hereinafter, the transmission beamforming is taken as an example. The beam pattern is determined based on a phase and an amplitude of a signal transmitted from each of multiple antennas. However, in order for the transmission station to direct the main beam to arbitrary N directions (N is a natural number), N Radio frequency (RF) systems are required.

### CITATION LIST

### Non-Patent Literature

NPL 1: “Enhanced Multiuser Transmission and Network Assisted Interference Cancellation”, 3GPP TSG RAN Meeting #66, December 2014.

### SUMMARY OF THE INVENTION

Problems to be Solved by the Invention

However, non-orthogonal multiplex transmission is a transmission method that the transmission station simultaneously transmits signals to M reception stations (M is a natural number) exceeding N RF systems provided to the transmission station itself. Therefore, the transmission station cannot direct the main beam to each of M reception stations non-orthogonal multiplexed. Similarly, also in non-orthogonal multiplex reception in which the reception station simultaneously receives signals transmitted from M transmission stations (M is a natural number) exceeding N RF systems provided to the reception station itself, the reception station cannot direct the main beam to each of M transmission stations.

The present invention has been made in consideration of such a circumstance, and an object is to provide a communication apparatus and a communication method that a transmission station and a reception station can simultaneously direct main beams the number of which exceeds the number N of RF systems provided to themselves to the reception station and transmission station, respectively.

### Means for Solving the Problems

To address the above-mentioned drawbacks, a communication apparatus and a communication method according to an aspect of the present invention are configured as follows.

(1) Specifically, a communication apparatus according to an aspect of the present invention is a communication apparatus for communicating with multiple terminal apparatuses, the communication apparatus including a transmission unit configured to generate non-orthogonal multiplexed signals in which at least some of downlink signals addressed to the multiple terminal apparatuses are mapped on the same radio resource, an antenna capable of forming an antenna directivity pattern including multiple main beams, and a transmission beam control unit configured to generate a signal controlling the antenna directivity pattern, wherein the non-orthogonal multiplexed signals are simultaneously transmitted by use of the multiple main beams, and the number of main beams included in the antenna directivity pattern is more than the number of RF systems of the antenna.

(2) The communication apparatus according to an aspect of the present invention is the communication apparatus described in (1) above, in which the antenna sets gains of the multiple main beams to values different from each other.

(3) The communication apparatus according to an aspect of the present invention is the communication apparatus described in (1) above, in which the antenna sets half-value widths of the multiple main beams to values different from each other.

(4) The communication apparatus according to the present invention is the communication apparatus described in any of (1) to (3) above, in which the transmission unit generates multiple reference signals to be transmitted in antenna directivity patterns different from each other via the antenna.

(5) The communication apparatus according to an aspect of the present invention is the communication apparatus described in any of (1) to (3) above, in which the transmission beam control unit acquires information controlling the antenna directivity pattern.

(6) The communication apparatus according to an aspect of the present invention is the communication apparatus described in (2) above, in which the transmission unit notifies at least one of the multiple terminal apparatuses of the information associated with the gains of the multiple main beams.

(7) The communication apparatus according to an aspect of the present invention is the communication apparatus described in any of (1) to (3) above, in which the antenna is a surface scattering antenna including metamaterial elements.

(8) A communication apparatus according to an aspect of the present invention is a communication apparatus for communicating with multiple terminal apparatuses, the communication apparatus including an antenna capable of forming an antenna directivity pattern including multiple main beams, a reception beam control unit configured to generate a signal controlling the antenna directivity pattern, and a reception unit configured to demodulate signals received in which signals at least some of uplink signals transmitted by the multiple terminal apparatuses are non-orthogonally multiplexed on the same radio resource, wherein at least some of the uplink signals transmitted by the multiple terminal apparatuses included in the signals non-orthogonal multiplexed and received are simultaneously received by use of the multiple main beams different from each other, and the number of main beams included in the antenna directivity pattern is more than the number of RF systems of the antenna.

(9) A communication apparatus according to an aspect of the present invention is a communication apparatus for communicating with a terminal apparatus, the communication apparatus including a transmission unit configured to generate signals addressed to the terminal apparatus, an antenna capable of forming an antenna directivity pattern including multiple main beams, and a transmission beam control unit configured to direct the multiple main beams to at least one of multiple paths grasped by the communication apparatus itself, wherein the signals addressed to the terminal apparatus are simultaneously transmitted by use of the multiple main beams, and the number of main beams included by the antenna directivity pattern is more than the number of RF systems of the antenna.

(10) The communication apparatus according to an aspect of the present invention is the communication apparatus described in (9) above, the communication apparatus further including a control unit configured to control a radio parameter associated with channel delay spread, based on the antenna directivity pattern or a signal controlling the antenna directivity pattern, the signal being generated by the transmission beam control unit.

(11) A communication method according to an aspect of the present invention is a communication method of a communication apparatus for communicating with multiple terminal apparatuses, the communication method including the steps of generating non-orthogonal multiplexed signals in which at least some of downlink signals addressed to the multiple terminal apparatuses are mapped on the same radio resource, forming an antenna directivity pattern including multiple main beams, generating a signal controlling the antenna directivity pattern, and simultaneously transmitting the non-orthogonal multiplexed signals by use of the multiple main beams, wherein the number of main beams included in the antenna directivity pattern is more than the number of RF systems of the antenna.

### Effects of the Invention

According to an aspect of the present invention, a transmission station and a reception station can simultaneously direct main beams the number of which exceeds the number N of RF systems provided to themselves to the reception station and transmission station, respectively, which improves reception quality of the signals, and thus, improves frequency efficiency of the communication system.

### BRIEF DESCRIPTION OF THE DRAWINGS

FIG. 1 is a diagram illustrating an example of a communication system according to an aspect of the present invention.

FIG. 2 is a block diagram illustrating one configuration example of a base station apparatus according to an aspect of the present invention.

FIG. 3 is a block diagram illustrating one configuration example of an antenna according to an aspect of the present invention.

FIG. 4 is a schematic diagram illustrating a situation of antenna directivity pattern control according to an aspect of the present invention.

FIG. 5 is a schematic diagram illustrating a situation of antenna directivity pattern control according to an aspect of the present invention.

FIG. 6 is a block diagram illustrating one configuration example of a terminal apparatus according to an aspect of the present invention.

### MODE FOR CARRYING OUT THE INVENTION

A communication system according to the present embodiment includes a base station apparatus (a transmission unit, cells, a transmission point, a group of transmit antennas, a group of transmit antenna ports, component carriers, eNodeB, access points, AP, wireless routers, repeaters, communication apparatuses) and terminal apparatuses (a terminal, a mobile terminal, a reception point, a reception terminal, a reception unit, a group of receive antennas, a group of receive antenna ports, a UE, a station, an STA).

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

### 1. First Embodiment

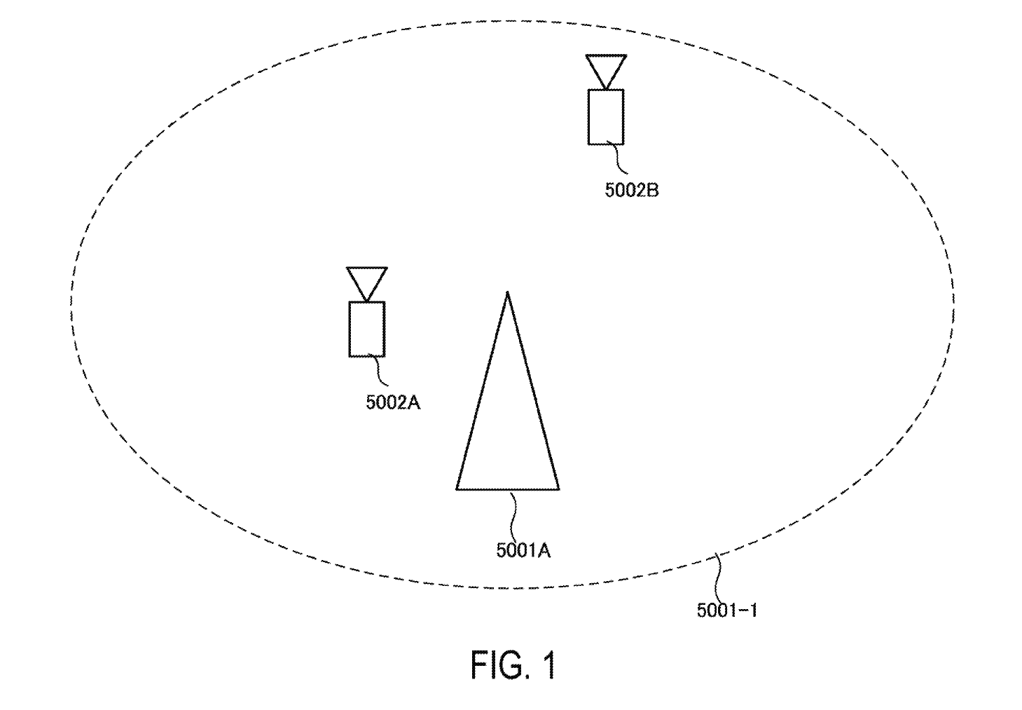

FIG. 1 is a diagram illustrating an example of a communication system according to the present embodiment. As illustrated in FIG. 1, the communication system according to the present embodiment includes a base station apparatus 5001A and terminal apparatuses 5002A and 5002B. A coverage 5001-1 is a range (a communication area) in which the base station apparatus 5001A can connect to the terminal apparatuses. The terminal apparatuses 5002A and 5002B are also collectively referred to as terminal apparatuses 5002.

With respect to FIG. 1, the following uplink physical channels are used for uplink radio communication from the terminal apparatus 5002A to the base station apparatus 5001A. The uplink physical channels are used for transmission of information output from higher layers.
Physical Uplink Control Channel (PUCCH)
Physical Uplink Shared Channel (PUSCH)
Physical Random Access Channel (PRACH)

The PUCCH is used for transmission of Uplink Control Information (UGI). The Uplink Control Information includes a positive acknowledgement (ACK) or a negative acknowledgement (NACK) (ACK/NACK) for downlink data (a downlink transport block or a Downlink-Shared Channel (DL-SCH)). ACK/NACK for the downlink data is also referred to as HARQ-ACK or HARQ feedback.

Here, the Uplink Control Information includes Channel State Information (CSI) for the downlink. The Uplink Control Information includes a Scheduling Request (SR) used to request an Uplink-Shared Channel (UL-SCH) resource. The Channel State Information refers to a Rank Indicator RI specifying a suited spatial multiplexing number, a Precoding Matrix Indicator PMI specifying a suited precoder, a Channel Quality Indicator CQI specifying a suited transmission rate, and the like.

The Channel Quality Indicator (hereinafter, referred to as a CQI value) can be a suited modulation scheme (e.g., QPSK, 16QAM, 64QAM, 256QAM, or the like) and a suited code rate in a prescribed band (details of which will be described later). The CQI value can be an index (CQI Index) determined by the above change scheme, coding rate, and the like. The CQI value can take a value determined beforehand in the system.

The Rank Indicator and the Precoding Quality Indicator can take the values determined beforehand in the system. Each of the Rank Indicator, the Precoding Matrix Indicator, and the like can be an index determined by the number of spatial multiplexing, Precoding Matrix information, or the like. Note that values of the Rank Indicator, the Precoding Matrix Indicator, and the Channel Quality Indicator CQI are collectively referred to as CSI values.

PUSCH is used for transmission of uplink data (an uplink transport block, UL-SCH). Furthermore, PUSCH may be used for transmission of ACK/NACK and/or Channel State Information along with the uplink data. In addition, PUSCH may be used to transmit the Uplink Control Information only.

PUSCH is used to transmit an RRC message. The RRC message is a signal/information that is processed in a Radio Resource Control (RRC) layer. Further, PUSCH is used to transmit an MAC Control Element (CE). Here, MAC CE is a signal/information that is processed (transmitted) in a Medium Access Control (MAC) layer.

For example, a power headroom may be included in MAC CE and may be reported via PUSCH. In other words, a MAC CE field may be used to indicate a level of the power headroom.

PRACH is used to transmit a random access preamble.

In the uplink radio communication, an Uplink Reference Signal (UL RS) is used as an uplink physical signal. The uplink physical signal is not used for transmission of information output from higher layers, but is used by the physical layer. The Uplink Reference Signal includes a Demodulation Reference Signal (DMRS) and a Sounding Reference Signal (SRS).

The DMRS is associated with transmission of PUSCH or PUCCH. For example, the base station apparatus 5001A uses DMRS in order to perform channel compensation of PUSCH or PUCCH. The SRS is not associated with the transmission of PUSCH or PUCCH. For example, the base station apparatus 5001A uses the SRS to measure an uplink channel state.

In FIG. 1, the following downlink physical channels are used for the downlink radio communication from the base station apparatus 5001A to the terminal apparatus 5002A. The downlink physical channels are used for transmission of information output from higher layers.
Physical Broadcast Channel (PBCH)
Physical Control Format Indicator Channel (PCFICH)
Physical Hybrid automatic repeat request Indicator Channel (PHICH: HARQ indicator channel)
Physical Downlink Control Channel (PDCCH)
Enhanced Physical Downlink Control Channel (EPDCCH)
Physical Downlink Shared Channel (PDSCH)

PBCH is used for broadcasting a Master information Block (MIB, a Broadcast Channel (BCH)) that is shared by the terminal apparatuses. PCFICH is used for transmission of information indicating a region (e.g., the number of OFDM symbols) to be used for transmission of PDCCH.

PHICH is used for transmission of ACK/NACK with respect to uplink data (a transport block, a codeword) received by the base station apparatus 5001A. In other words, PHICH is used for transmission of a HARQ indicator (HARQ feedback) indicating ACK/NACK with respect to the uplink data. Note that ACK/NACK is also called HARQ-ACK. The terminal apparatus 5002A reports ACK/NACK having been received to a higher layer. ACK/NACK refers to ACK indicating a successful reception, NACK indicating an unsuccessful reception, and DTX indicating that no corresponding data is present. In a case that PHICH for uplink data is not present, the terminal apparatus 5002A reports ACK to a higher layer.

The PDCCH and the EPDCCH are used for transmission of Downlink Control Information (DCI). Here, multiple DCI formats are defined for transmission of the downlink control information. In other words, a field for the downlink control information is defined in a DCI format and is mapped to information bits.

For example, as a DCI format for the downlink, DCI format 1A to be used for the scheduling of one PDSCH in one cell (transmission of a single downlink transport block) is defined.

For example, the DCI format for the downlink includes downlink control information such as information on PDSCH resource allocation, information on a Modulation and Coding Scheme (MCS) for PDSCH, a TPC command for PUCCH, and the like. Here, the DCI format for the downlink is also referred to as downlink grant (or downlink assignment).

Furthermore, for example, as a DCI format for the uplink, DCI format 0 to be used for the scheduling of one PUSCH in one cell (transmission of a single uplink transport block) is defined.

For example, the DCI format for the uplink includes uplink control information such as information on PUSCH resource allocation, information on MCS for PUSCH, a TPC command for PUSCH, and the like. Here, the DCI format for the uplink is also referred to as uplink grant (or uplink assignment).

Further, the DCI format for the uplink can be used to request the downlink Channel State Information (CSI) (CSI request), which is also called reception quality information. The Channel State Information refers to the Rank Indicator (RI) specifying a suited number of spatial multiplexing, the Precoding Matrix Indicator (PMI) specifying a suited precoder, the Channel Quality Indicator (CQI) specifying a suited transmission rate, Precoding type Indicator (PTI) and the like.

The DCI format for the uplink can be used for a configuration indicating an uplink resource to which a CSI feedback report is mapped, the CSI feedback report being fed back to the base station apparatus by the terminal apparatus, For example, the CSI feedback report can be used for a configuration indicating an uplink resource for periodically reporting Channel State Information (Periodic CSI). The CSI feedback report can be used for a mode configuration (CSI report mode) to periodically report the Channel State Information.

For example, the CSI feedback report can be used for a configuration indicating an uplink resource to report aperiodic Channel State Information (Aperiodic CSI). The CSI feedback report can be used for a mode configuration (CSI report mode) to aperiodically report the Channel State Information. The base station apparatus can configure any one of the periodic CSI feedback report and the aperiodic CSI feedback report. In addition, the base station apparatus can configure both the periodic CSI feedback report and the aperiodic CSI feedback report.

The DCI format for the uplink can be used for a configuration indicating a type of the CSI feedback report that is fed back to the base station apparatus by the terminal apparatus. The type of the CSI feedback report includes wideband CSI (e.g., Wideband CQI), narrowband CSI (e.g., Subband CQI), and the like.

In a case where a PDSCH resource is scheduled in accordance with the downlink assignment, the terminal apparatus receives downlink data on the scheduled PDSCH. In a case where a PUSCH resource is scheduled in accordance with the uplink grant, the terminal apparatus transmits uplink data and/or uplink control information on the scheduled PUSCH.

PDSCH is used for transmission of downlink data (a downlink transport block, DL-SCH). PDSCH is used to transmit a system information block type 1 message. The system information block type 1 message is cell-specific information.

PDSCH is used to transmit a system information message. The system information message includes a system information block X other than the system information block type 1. The system information message is cell-specific information.

PDSCH is used to transmit an RRC message. Here, the RRC message transmitted from the base station apparatus may be shared by multiple terminal apparatuses in a cell. Further, the RRC message transmitted from the base station apparatus 5001A may be a dedicated message to a given terminal apparatus 2 (also referred to as dedicated signaling). In other words, user-equipment-specific information (unique to user equipment) is transmitted using a message dedicated to the given terminal apparatus. PDSCH is used for transmission of MAC CE.

Here, the RRC message and/or MAC CE is also referred to as higher layer signaling.

PDSCH can be used to request downlink channel state information. PDSCH can be used for transmission of an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (Periodic CSI). The CSI feedback report can be used for a mode configuration (CSI report mode) to periodically report the Channel State Information.

The type of the downlink CSI feedback report includes wideband CSI (e.g., Wideband CSI) and narrowband CSI (e.g., Subband CSI). The wideband CSI calculates one piece of Channel State Information for the system band of a cell. The narrowband CSI divides the system band in predetermined units, and calculates one piece of Channel State information for each division.

In the downlink radio communication, a Synchronization signal (SS) and a DownLink Reference Signal (DL RS) are used as downlink physical signals. The downlink physical signals are not used for transmission of information output from the higher layers, but are used by the physical layer.

The Synchronization signal is used for the terminal apparatus to be synchronized to frequency and time domains in the downlink. The Downlink Reference Signal is used for the terminal apparatus to perform channel compensation on a downlink physical channel. For example, the Downlink Reference Signal is used for the terminal apparatus to calculate the downlink Channel State Information.

Here, the Downlink Reference Signals include a Cell-specific Reference Signal (CRS), a UE-specific Reference Signal (URS) or a terminal-specific reference signal relating to PDSCH, a Demodulation Reference Signal (DMRS) relating to EPDCCH, a Non-Zero Power Chanel State Information-Reference Signal (NZP CSI-RS), and a Zero Power Chanel State Information-Reference Signal (ZP CSI-RS).

CRS is transmitted in all bands of a suhframe and is used to perform demodulation of PBCH/PDCCH/PHICH/PCFICH/PDSCH. URS relating to PDSCH is transmitted in a suhframe and a band that are used for transmission of PDSCH to which URS relates, and is used to demodulate PDSCH to which URS relates.

DMRS relating to EPDCCH is transmitted in a subframe and a band that are used for transmission of EPDCCH to which DMRS relates. DMS is used to demodulate EPDCCH to which DMRS relates.

A resource for NZP CSI-RS is configured by the base station apparatus 5001A. The terminal apparatus 5002A performs signal measurement (channel measurement), using NZP CSI-RS. A resource for ZP CSI-RS is configured by the base station apparatus 5001A. With zero output, the base station apparatus 5001A transmits ZP CSI-RS, The terminal apparatus 5002A performs interference measurement in a resource to which NZP CSI-RS corresponds, for example.

A Multimedia Broadcast multicast service Single Frequency Network (MBSFN) RS is transmitted in all bands of the suhframe used for transmitting PMCH. MBSFN RS is used to demodulate PMCH. PMCH is transmitted on the antenna port used for transmission of MBSFN

Here, the downlink physical channel and the downlink physical signal are also collectively referred to as a downlink signal. The uplink physical channel and the uplink physical signal are also collectively referred to as an uplink signal. The downlink physical channels and the uplink physical channels are collectively referred to as physical channels. The downlink physical signals and the uplink physical signals are also collectively referred to as physical signals.

BCH, UL-SCH, and DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit. of data that the MAC layer delivers to the physical layer. In the physical layer, the transport block is mapped to a codeword and subject to coding processing or the like on a codeword basis.

The base station apparatus can multiplex multiple terminal apparatuses without dividing a resource by time, frequency, and space (e.g., an antenna port, a beam pattern, a precoding pattern). Hereinafter, multiplexing multiple terminal apparatuses without dividing a resource by time/frequency/space is also referred to as non-orthogonal multiplexing. Moreover, signals addressed to multiple terminal apparatuses, at least some of which signals are non-orthogonally multiplexed, are also referred to as non-orthogonal multiplexed signals. Although a case in which two terminal apparatuses are non-orthogonally multiplexed is described below, an aspect of the present invention is not limited thereto, and three or more terminal apparatuses can also be non-orthogonally multiplexed.

The base station apparatus can divide a resource by time, frequency, and space to multiplex multiple terminal apparatuses. Hereinafter, multiplexing multiple terminal apparatuses with dividing a resource by time, frequency, and space is also referred to as orthogonal multiplexing. Moreover, signals addressed to multiple terminal apparatuses, at least some of which signals are orthogonally multiplexed, are also referred to as orthogonal multiplexed signals. Although a case in which two terminal apparatuses are orthogonally multiplexed is described below, an aspect of the present invention is not limited thereto, and three or more terminal apparatuses can also be orthogonally multiplexed.

The terminal apparatus 5002A can receive parameters necessary for removing or preventing the interference signal from the base station apparatus 5001A, or can detect the stated parameters through blind detection. It may not be necessary for the terminal apparatus 5002B to remove or prevent the interference signal. in a case where the terminal apparatus 2B does not cancel the interference, the terminal apparatus 2B can demodulate a signal addressed to the terminal apparatus 2B because of relatively small interference signal power, although the terminal apparatus 2B does not learn the parameters associated with the interference signal. That is, in a case where the base station apparatus 5001A non-orthogonally multiplexes the terminal apparatuses 5002A and 5002B, the terminal apparatus 5002A needs to be equipped with a function to remove or prevent the interference signal due to the non-orthogonal multiplexing, but the terminal apparatus 5002B does not need to be equipped with a function to cancel or prevent the interference. To rephrase, the base station apparatus 5001A can non-orthogonally multiplex a terminal apparatus supporting the non-orthogonal multiplexing and a terminal apparatus not supporting the non-orthogonal multiplexing. In other words, the base station apparatus 5001A can non-orthogonally multiplex the terminal apparatuses in which different transmission modes are configured. Accordingly, the communication opportunity of each terminal apparatus can be enhanced.

The base station apparatus 5001A transmits, to the terminal apparatus 5002A, information (assist information, auxiliary information, control information, configuration information) on the terminal apparatus that interferes (the terminal apparatus 5002B in this example). The base station apparatus 5001A can transmit, by higher layer signaling or physical layer signaling (control signal, PDCCH, EPDCCH), the information on the terminal apparatus that interferes (NAICS (Network Assisted Interference Cancellation and Suppression) information, NAICS assist information, NAICS configuration information, Multiuser (MU)-NAILS information, MU-NAICS assist information, MU-NAICS configuration information, Non Orthogonal Multiple Access (NOMA) information, NOMA assist information, NOMA configuration information).

The MU-NAICS assist information includes part of or all of information on PA, the transmission mode, information on transmit power of the UE-specific Reference Signal, information on transmit power on PDSCH of the interference signal, PMI, information on PA of the serving cell, information on transmit power of the UE-specific Reference Signal of the serving cell, the modulation scheme, the Modulation and Coding Scheme (MCS), a Redundancy Version, and a Radio Network Temporary Identifier (RNTI).

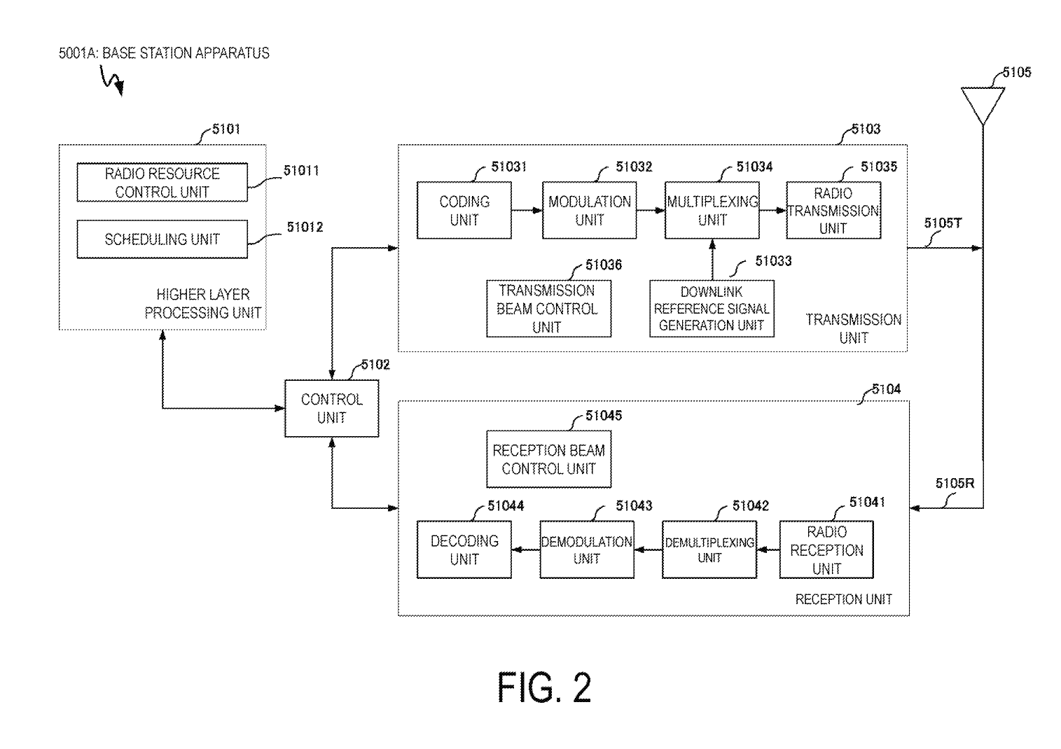

FIG. 2 is a schematic block diagram illustrating a configuration of the base station apparatus 5001A according to the present embodiment. As illustrated in FIG. 2, the base station apparatus 5001A is configured, including a higher layer processing unit (higher layer processing step) 5101, a control unit (controlling step) 5102, a transmission unit (transmitting step) 5103, a reception unit (receiving step) 5104, and an antenna 5105. The higher layer processing unit 5101 is configured, including a radio resource control unit (radio resource controlling step) 51011 and a scheduling unit (scheduling step) 51012, The transmission unit 5103 is configured, including a coding unit (coding step) 51031, a modulation unit (modulating step) 51032, a downlink reference signal generation unit. (downlink reference signal generating step) 51033, a multiplexing unit (multiplexing step) 51034, a radio transmission unit (radio transmitting step) 51035, and a beam control unit (beam controlling step) 51036. The reception unit 5104 is configured, including a radio reception unit (radio receiving step) 51041, a demultiplexing unit (demultiplexing step) 51042, a demodulation unit (demodulating step) 51043, and a decoding unit (decoding step) 51044.

The higher layer processing unit 5101 performs processing of the Medium Access Control (MAC) layer, a Packet Data Convergence Protocol (PDCP) layer, a Radio Link Control (RLC) layer, and a Radio Resource Control (RRC) layer. Furthermore, the higher layer processing unit 5101 generates information necessary for control of the transmission unit 5103 and the reception unit 5104, and outputs the generated information to the control unit 5102.

The higher layer processing unit 5101 receives information on a terminal apparatus, such as UE capability or the like, from the terminal apparatus. To rephrase, the terminal apparatus transmits its function to the base station apparatus by higher layer signaling,

Note that in the following description, information on a terminal apparatus includes information indicating whether the stated terminal apparatus supports a prescribed function, or information indicating that the stated terminal apparatus has completed the introduction and test of a prescribed function. In the following description, information on whether the prescribed function is supported includes information on whether the introduction and test of the prescribed function have been completed.

For example, in a case that a terminal apparatus supports a prescribed function, the stated terminal apparatus transmits information (parameters) indicating whether the prescribed function is supported. In a case that a terminal apparatus does not support a prescribed function, the stated terminal apparatus does not transmit information (parameters) indicating whether the prescribed function is supported. In other words, whether the prescribed function is supported is reported by whether information (parameters) indicating whether the prescribed function is supported is transmitted. Information (parameters) indicating whether a prescribed function is supported may be reported using one bit of 1 or 0.

The radio resource control unit 51011 generates, or acquires from a higher node, the downlink data (the transport block) arranged in the downlink PDSCH, system information, the RRC message, the MAC CE, and the like. The radio resource control unit 51011 outputs the downlink data to the transmission unit 5103, and outputs other information to the control unit 5102. Furthermore, the radio resource control unit 51011 manages various configuration information on the terminal apparatuses.

The scheduling unit 51012 determines a frequency and a subframe to which the physical channels (PDSCH and PUSCI-I) are allocated, the coding rate and modulation scheme (or MCS) for the physical channels (PDSCH and PUSCH), the transmit power, and the like. The scheduling unit 51012 outputs the determined information to the control unit 5102

The scheduling unit 51012 generates the information to be used for the scheduling of the physical channels (PDSCH and MISCH), based on the result of the scheduling. The scheduling unit 51012 outputs the generated information to the control unit 5102.

Based on the information input from the higher layer processing unit 5101, the control unit 5102 generates a control signal for controlling of the transmission unit 5103 and the reception unit 5104. The control unit 5102 generates the Downlink Control Information, based on the information input from the higher layer processing unit 5101, and outputs the generated information to the transmission unit 5103.

The transmission unit 5103 generates the downlink reference signal in accordance with the control signal input from the control unit 5102, codes and modulates the HARQ indicator, the downlink control information, and the downlink data that are input from the higher layer processing unit 5101, multiplexes PHICH, PDCCH, EPDCCH, PDSCH, and the downlink reference signal, and transmits a signal obtained through the multiplexing to the terminal apparatus 5002 through the antenna 5105.

The coding unit 51031 codes the HARQ indicator, the Downlink Control Information, and the downlink data that are input from the higher layer processing unit 5101, in compliance with the coding scheme prescribed in advance, such as block coding, convolutional coding, or turbo coding, or in compliance with the coding scheme determined by the radio resource control unit 51011. The modulation unit 51032 modulates the coded bits input from the coding unit 51031, in compliance with the modulation scheme prescribed in advance, such as Binary Phase Shift Keying (BPSK), quadrature Phase Shift Keying (QPSK), 16 quadrature amplitude modulation (16QAM), 64QAM, or 256QAM, or in compliance with the modulation scheme determined by a radio resource control unit 52011.

The downlink reference signal generation unit 51033 generates, as the downlink reference signal, a sequence that is already known to the terminal apparatus 5002A and that is acquired in accordance with a rule prescribed in advance based on the physical cell identity (PCI, cell ID) for identifying the base station apparatus 5001A, and the like.

The multiplexing unit 51034 multiplexes the modulated modulation symbol of each channel, the generated downlink reference signal, and the downlink control information, To be more specific, the multiplexing unit 51034 maps the modulated modulation symbol of each channel, the generated downlink reference signal, and the downlink control information in the resource elements.

The radio transmission unit 51035 performs Inverse Fast Fourier Transform (IFFT) on the modulation symbol resulting from the multiplexing or the like to generate an OFDM symbol, attaches a cyclic prefix (CP) to the generated OFDM symbol to generate a baseband digital signal, converts the baseband digital signal into an analog signal, removes unnecessary frequency components through filtering, and outputs a final result to the antenna 5105.

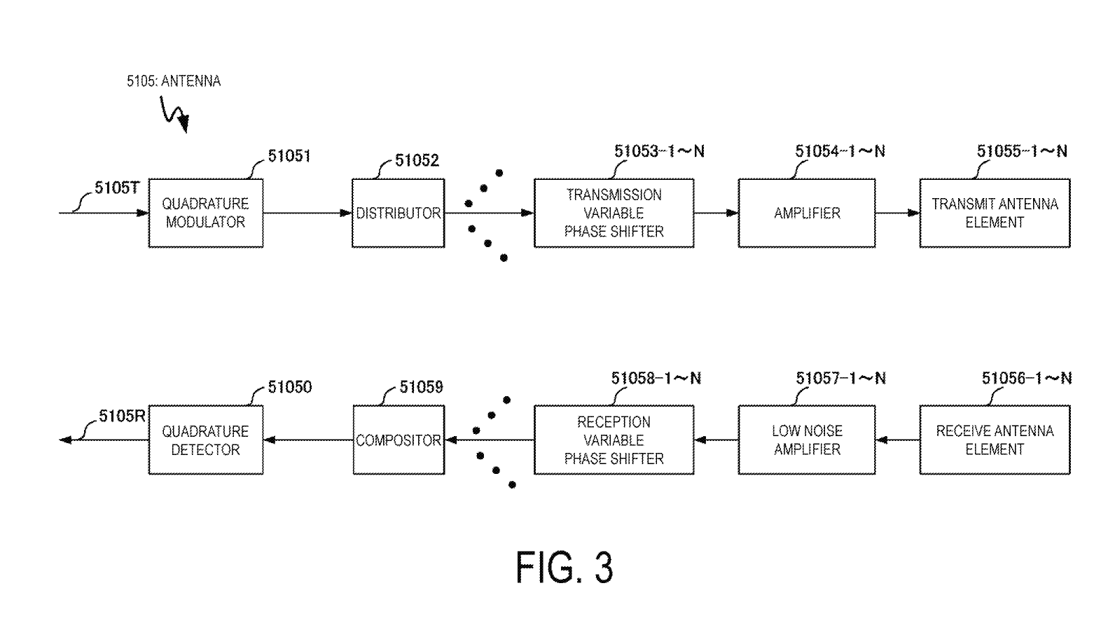

FIG. 3 is a block diagram illustrating one configuration example of the antenna. 5105 according to the present embodiment. As illustrated in FIG. 3, the antenna 5105 includes at least a quadrature modulator 51051, a distributor 51052, transmission variable phase shifters 51053-1 to 51053-N, amplifiers 51054-1 to 51054-N, transmit antenna elements 51055-1 to 51055-1-N, receive antenna elements 51056-1 to 51056-N, low noise amplifiers 51057-1 to 51057-N, reception variable phase shifters 51058-1 to 51058-N, a compositor 51059, and a quadrature detector 51050. The transmission variable phase shifter 51053 and the reception variable phase shifter 51058 may be a common shifter. The transmit antenna elements 51055-1 to 51055-N and the receive antenna elements 51056-1 to 51056-N may be common elements. Hereinafter, although a description is given assuming that the number of transmit antenna elements and the number of receive antenna elements are N, the method according to the present embodiment is not limited in a value of N. Of course, the number of transmit antenna elements and the number of receive antenna elements may be different from each other. Note that a reference sign 5105T designates antenna input which is output from the transmission unit 5103, and a reference sign 5105R designates antenna output which is input to the reception unit 5104.

The quadrature modulator 51051 up-converts a signal input from the transmission unit 5103 into a signal of a carrier frequency. The distributor 51052 distributes the signal up-converted into that of a carrier frequency to the transmit antenna elements, The transmission variable phase shifter 51053 and the amplifier 51054 change phases and amplitudes of signals to be transmitted from the corresponding transmit antenna element 51055.

In the present embodiment, assume that the number of signal inputs to the quadrature modulator 51051 is the number of inputs of the antenna 5105. In general, as for a phase modulated signal in compliance with QPSK and the like, two signals of an in-phase axis signal (I-axis signal) and a quadrature axis signal (Q-axis signal) are input to the quadrature modulator 51051, but in the present embodiment, an I-axis signal and a Q-axis signal are collectively counted as one signal. Note that the I-axis signal and the Q-axis signal are generated by a digital/analog converter (DAC) (illustration of which is omitted in FIG. 2 and FIG. 3) for signals in a baseband zone, and therefore, the number of DACs can be said to be the number of inputs of the antenna 5105. Needless to say, a DAC is necessary for each of the I-axis signal and the Q-axis signal with respect to one modulated signal, but a DAC for I-axis signal and a DAC for Q-axis signal are collectively counted as one DAC.

Here, the configuration of the antenna 5105 according to the present embodiment is not limited to the example illustrated in FIG. 3. For example, the quadrature modulator 51051 may be configured to be included in the transmission unit 5103. In this case, the number of outputs of the quadrature modulator 51051 is the number of inputs of the antenna 5105. Further, the distributor 51052 may be also configured to be included in the reception unit 5104. In this case, the number of inputs of the antenna 5105 is the number of outputs of the distributor 51052. However, the signals output from the distributor 51052 are identical signals, and thus a description is given assuming that the number of distributors 51052 is the number of inputs of the antenna 5105. The antenna 5105 may further include an amplifier between the distributor 51052 and the quadrature modulator 51051. In the antenna 5105, the amplifier 51054 may be arranged before the transmission variable phase shifter 51053.

The transmission beam control unit 51036 according to the present embodiment can control the transmission variable phase shifter 51053 and the amplifier 51054. Hereinafter, a case is dealt with that the transmission beam control unit 51036 controls the transmission variable phase shifter 51053, but the present embodiment includes a case that the transmission beam control unit 51036 controls only the amplifier 51054 and a case that the transmission beam control unit 51036 controls both the transmission variable phase shifter 51053 and the amplifier 51054.

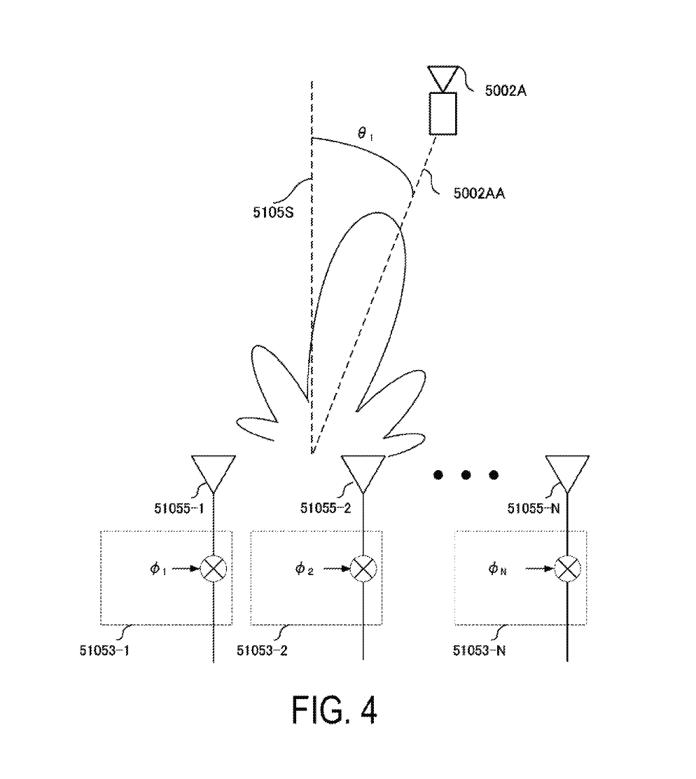

FIG. 4 is a schematic diagram illustrating a principle for forming a beam pattern (antenna directivity pattern). In FIG. 4, assume that N transmit antenna elements 51055 are arranged at equal antenna distances d to form a linear antenna array. In a case that a phase change amount given by the transmission variable phase shifter 51053-n is θn, when an angle between a radiation direction 5105S of the antenna 5105 and a direction 5002AA of a position (position direction) of the terminal apparatus 5002A is θ1, a reception signal of the terminal apparatus 5002A is expressed by Equation (1).

$$\begin{matrix}[ Equation 1 ] & \\ r = ( {\sum }_{n = 1}^{N} exp ( jknd sin {θ}_{1} ) exp ( j {φ}_{n} ) ) x + β & ( 1 )\end{matrix}$$

Here, assume that s represents a downlink signal addressed to the terminal apparatus 5002A generated by the transmission unit 5103 in the base station apparatus 5001A, an average power of which downlink signal is P. Moreover, β represents a noise component with zero mean and variance (average power) σ2 observed by the terminal apparatus 5002A. Further, k represents a Wave number. In Equation (1), an effect of multipath fading is not taken into consideration. It can be seen from Equation (1) that an average reception Signal-to-noise power ratio (SNR) γ1 of the reception signal of the terminal apparatus 5002A is expressed by Equation (2).

$$\begin{matrix}[ Equation 2 ] & \\ {γ}_{1} = \frac{P}{{σ}^{2}} {‖ {\sum }_{n = 1}^{N} exp ( jknd sin {θ}_{1} ) exp ( j {φ}_{n} ) ‖}^{2} & ( 2 )\end{matrix}$$

It can be seen from Equation (2) that the reception SNR is associated with the phase change amount φn given by the transmission variable phase shifter 51055-n. For example, the transmission beam control unit 51036 can maximize the reception SNR of the terminal apparatus 5002A by giving φn of which maximum is γ1 to the transmission variable phase shifter 51053, which improves the reception quality of the terminal apparatus 5002A. On the other hand, the transmission beam control unit 51036 can minimize the reception SNR of the terminal apparatus 5002A by giving φn of which minimum is γ1 to the transmission variable phase shifter 51053, which controls such that a signal addressed to another terminal apparatus (e.g., the terminal apparatus 5002B) is not received by the terminal apparatus 5002A by use of the above φn when transmitting the signal. Hereinafter, control of the beam pattern performed by the transmission beam control unit 51036 with respect to the terminal apparatus 5002A is also referred to as beamforming control (or beam control, merely) with respect to the terminal apparatus 5002A.

A high gain part in the antenna directivity pattern generated by the antenna 5105 is called a main beam or merely a beam. Control performed by the transmission beam control unit 51036 according to the present embodiment includes control for generating a high gain part in the antenna directivity pattern initiated by antenna 5105. In the following description associated with the antenna 5105, at least a part of signals processing and controlling performed when the base station apparatus 5001A transmits the downlink signal of the terminal apparatus 5002 can be performed also when the base station apparatus 5001A receives the uplink signal of the terminal apparatus 5002.

Here, the phase change amount given to each transmission variable phase shifter 51053 is one kind for each shifter 51053. Therefore, according to the configuration of the antenna 5105 in FIG. 4, the main beam can only be directed arbitrarily to one direction in the antenna directivity pattern which the transmission beam control unit 51036 can form with the antenna 5105. Then, in a case that the transmission unit 5103 generates a signal in which a signal addressed to the terminal apparatus 5002A and a signal addressed to the terminal apparatus 5002B are non-orthogonal multiplexed, and positions of the terminal apparatus 5002A and terminal apparatus 5002B are away from each other, the transmission beam control unit 51036 cannot form the antenna directivity pattern in which a main beam direction is simultaneously directed in directions of both terminal apparatuses.

Therefore, the transmission beam control unit 51036 according to the present embodiment divides N transmit antenna elements 51055 included in the antenna 5105 into two groups each of which includes (N/2) elements, in order to form a beam pattern improving the reception SNR of the terminal apparatus 5002A and terminal apparatus 5002B connected to the base station apparatus 5001A.

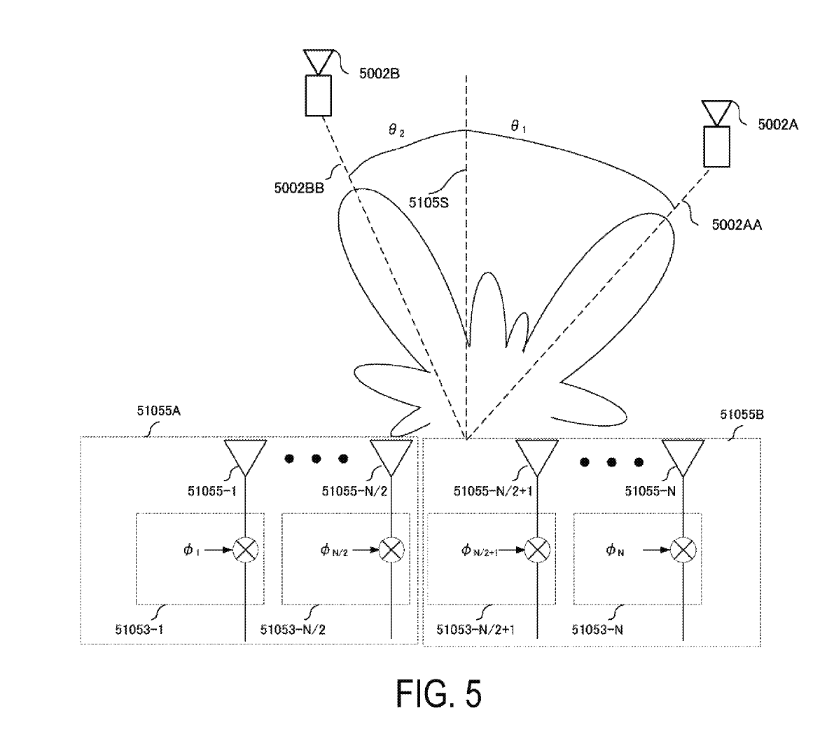

FIG. 5 is a schematic diagram illustrating a principle for forming a beam pattern of the antenna 5105 according to the present embodiment. Here, assume that the transmit antenna elements 51055-1 to 51055-N/2 are included in an antenna group 51055A, and the transmit antenna elements 51055-N/2+1 to 51055-N are included in an antenna group 51055B.

The transmission beam control unit 51036 performs beam forming control of the terminal apparatus 5002A positioned in the position direction 5002AA with the antenna group 51055A. At the same time, the transmission beam control unit 51036 performs beamforming control of the terminal apparatus 5002B positioned in a position direction 50029 with the antenna group 51055B. As a result, the antenna directivity pattern formed by the antenna 5105 is that composed of the antenna directivity pattern formed by the antenna group 51055A and the antenna directivity pattern formed by the antenna group 51055B. Therefore, the antenna directivity pattern formed by the antenna 5105 is directed to both the terminal apparatus 5002A and the terminal apparatus 5002B as illustrated in FIG. 5.

On the other hand, in the antenna 5105 according to the present embodiment, the signals input to the antenna groups are in common. To be more specific, a common signal output from one distributor 51052 is configured to be input to each antenna group. In the present embodiment, the signals input to the antenna groups are in common, and the number of main beams included in the antenna directivity pattern of the antenna 5105 is more than the number of inputs of the antenna 5105. Therefore, the base station apparatus 5001A according to the present embodiment can be said to be able to control multiple main beams by less quadrature modulators 51051 and distributors 51052. As described in the previous description, the number of inputs of the antenna 5105 is also associated with the number of DACs included in the transmission unit 5103, and the base station apparatus 5001A according to the present embodiment can form the antenna directivity pattern including the main beams the number of which is more than the number of DACs. Hereinafter, a system including at least one of the DAC, the quadrature modulator 51051, and the distributor 51052 is also referred to as an RF system, The base station apparatus 5001A according to the present embodiment can form the antenna directivity pattern including the main beams the number of which is M (M is a natural number) more than the number N of RF systems (N is a natural number, M>N) provided to the base station apparatus 5001A itself. The base station apparatus 5001A can direct M main beams to M terminal apparatuses for which the downlink signals are non-orthogonally multiplexed.

The above method can also apply to a case that the base station apparatus 5001A directs M main beams to M terminal apparatuses for which the downlink signals are orthogonally multiplexed.

The antenna 5105 according to the present embodiment can form the beams the number of which is more than the number of input signals. Here, the signals input to the antenna 5105 are the signals output from the transmission unit 5103, and thus the antenna 5105 according to the present embodiment can be said to be able to form the beams the number of which is more than the number of signals generated by the transmission unit 5103.

Note that the antenna 5105 according to the present embodiment can be configured to include multiple distributors 51052. However, in this case also, the number of main beams formed by the antenna. 5105 is controlled to exceed the number of distributors 51052.

The antenna 5105 according to the present embodiment can control the antenna directivity pattern not only in a horizontal direction but also in a vertical direction. For example, the transmission beam control unit 51036 can direct a main boom to, besides a direction at an angle with the radiation direction of antenna 5105 in the horizontal direction, a direction at an angle with the radiation direction of the antenna 5105 in the vertical direction, as the information on the position directions of the terminal apparatus 5002A and the terminal apparatus 5002B. Of course, by similarly controlling each of multiple antenna groups included in the antenna 5105, the transmission beam control unit 51036 can control each of multiple main beams in the horizontal direction and vertical direction.

The transmission beam control unit 51036 according to the present embodiment can acquire information for controlling the antenna directivity pattern of the antenna 5105. The information for controlling the antenna directivity pattern includes positional information, horizontal angle information, vertical angle information, latitude and longitude information, reception quality and the like of the terminal apparatus 5002, for example.

The transmission unit 5103 in the base station apparatus 5001A according to the present embodiment can transmit multiple reference signals (pilot signal, reference signal, training signal, RS, TF). The transmission unit 5103 can transmit multiple reference signals with the antenna directivity pattern of the antenna 5105 being varied. The transmission unit 5103 can transmit the RS in such a manner that when a transmitted RS is received by a prescribed terminal apparatus (e.g., the terminal apparatus 5002A), the terminal apparatus 5002A can distinguish the antenna directivity pattern applied to the RS. For example, the transmission unit 5103 can include information identifying the antenna directivity pattern (beam ID) in PDCCH and PDSCH for the signal including the RS. The transmission unit 5103 can also transmit the RS in the different radio resources.

The transmission beam control unit 51036 can acquire the information for controlling the antenna directivity pattern, based on feedback information from the terminal apparatus 5002. The transmission beam control unit 51036 can acquire the beam ID included in the RS or information capable of identifying the radio resource on which the RS is transmitted which is notified by a prescribed terminal apparatus receiving the relevant RS (e.g., the terminal apparatus 5002A).

The transmission beam control unit 51036 can acquire the information for controlling the antenna directivity pattern from the uplink signal of the terminal apparatus 5002 received by the reception unit 5104 described later.

The antenna 5105 may acquire the information for controlling the antenna directivity pattern. For example, the antenna 5105 can estimate an arrival angle direction of the uplink signal transmitted by the terminal apparatus 5002 to direct the main beam to the estimated arrival angle direction. The method of acquiring the information for controlling the antenna directivity pattern of the antenna 5105 by the transmission beam control unit 51036 described above can be also carried out by the reception beam control unit 51045 described later.

In the above description, the case that the base station apparatus 5001A non-orthogonally multiplexes the downlink signals addressed to two terminal apparatuses 5002 (that is, the terminal apparatus 5002A and the terminal apparatus 5002B) is described as an example. The base station apparatus 5001.A according to the present embodiment can also non-orthogonally multiplex the downlink signals addressed to three or more terminal apparatuses 5002. For example, the antenna 5105 can divide the transmit antenna elements 51055 into three or more antenna groups. The transmission beam control unit 51036 can control the main beam of each antenna group, and thus, can direct the main beam of each antenna group to the position direction of each terminal apparatus 5002.

The base station apparatus 5001A can set the numbers of transmit antenna elements 51055 included in the respective antenna groups to values different from each other. For example, using FIG. 5 as an example, the base station apparatus 5001A can include the transmit antenna elements 51055-1 to 51055-N/4 in the antenna group 51055A, and can include the transmit antenna elements 51055-N/4+1 to 51055-N in the antenna group 51055B. By controlling in this way, the base station apparatus 5001A can control the gain as well as the directions of multiple main beams included in the antenna directivity pattern generated by the antenna 5105. The method of providing a gain difference to the main beam by the base station apparatus 5001A is not limited to this example. For example, the base station apparatus 5001A may control the amplifier 51054 included in the antenna group to provide the gain difference to the main beam.

For example, in a case that a distance between the base station apparatus 5001A and the terminal apparatus 5002A is substantially the same as a distance between the base station apparatus 5001A and the terminal apparatus 5002B, the base station apparatus 5001A can provide a difference between the gains of two main beams directed to the terminal apparatuses 5002 to improve an efficiency of non-orthogonal multiplex performed by the base station apparatus 5001A. Of course, the base station apparatus 5001A may provide the gain difference between multiple main beams regardless of the distances from the terminal apparatuses.

The transmission unit 5103 according to the present embodiment can notify the terminal apparatus 5002A and the terminal apparatus 5002B of information associated with the gains of multiple main beams. The transmission unit 5103 can notify the terminal apparatus 5002A and the terminal apparatus 50028 of transmit powers of the downlink signals of the respective terminal apparatuses 5002, as the information associated with the gains of multiple main beams.

The base station apparatus 5001A can adjust a width (half-value width) of the main beam formed by each antenna group. For example, using FIG. 5 as an example, the base station apparatus 5001A can skip and use every two transmit antenna elements 51055-1 to 51055-N/2 included in the antenna group 51055A (i.e., transmit antenna elements 51055-1, 51055-3, 51055-5, . . . ). By controlling in this way, the distance between the transmit antenna elements in the antenna group 51055A is two times the distance between the transmit antenna elements in the antenna group 51055B, and thus the half-value width of the main beam formed by the antenna group 51055A is smaller than the half-value width of the main beam formed by the antenna group 51055B. The method of controlling the half-value width of the main beam formed by each antenna group by the transmission beam control unit 51036 is not limited to this example. For example, the transmission beam control unit 51036 can control the transmission variable phase shifter 51053 and the amplifier 51054 to control the half-value width of the main beam.

The base station apparatus 5001A can change the half-value widths of the main beams directed to the terminal apparatus 5002A and terminal apparatus 5002A depending on moving speeds of the respective terminal apparatuses 5002. For example, the transmission beam control unit 51036 can set the half-value width of the main beam directed to the terminal apparatus 5002A higher in the moving speed to be wider than that directed to the terminal apparatus 5002B lower in the moving speed. Of course, in a case that the moving speeds of both the terminal apparatus 5002A and the terminal apparatus 5002B are high, the base station apparatus 5001A can form the main beams having the half-value widths wider as compared with a case that the terminal apparatuses 5002 are in a resting state.

The antenna 5105 also has a function to receive signals transmitted from the terminal apparatus 5002A. The signals received by the receive antenna elements 51056 are input to the low noise amplifiers 51057 to be amplified to have prescribed powers. Next, the reception variable phase shifters 51058 control phases of the signals input to the receive antenna elements. The signals output from the reception variable phase shifters 51058 are input to the compositor 51059 to be composed into one signal. The signal composed by the compositor 51059 is input to the quadrature detector 51050, converted into a baseband signal from a carrier frequency band through down-converting to remove unnecessary frequency components, and then, input to the reception unit 5104 as an output of the antenna 5105.

In the following description, assume that the number of outputs of the quadrature detector 51050 is the number of outputs of the antenna 5105. Similar to the quadrature modulator 51051, the output of the quadrature detector 51050 also includes two outputs of the I-axis signal and Q-axis signal, but in the present embodiment, two outputs of the I-axis signal and Q-axis signal are collectively counted as one output. Moreover, the outputs of the quadrature detector 51050 are converted into digital signals by analog-digital converters (ADC) in the reception unit 5104 described later, and thus the number of ADCs in the reception unit 5104 is the same as the number of outputs of the antenna 5105. Of course, the ADC is also arranged for each of the I-axis signal and the Q-axis signal, but in the present embodiment, an ADC for I-axis signal and an ADC for Q-axis signal are collectively counted as one ADC.

Positions of the quadrature detector 51050 and compositor 51059 are not limited to the example in FIG. 3. For example, the base station apparatus 5001A according to the present embodiment can have a constitution in which the reception unit 5104 includes one or both of the quadrature detector 51050 and the compositor 51059.

The antenna unit 5105 according to the present embodiment can control the antenna directivity pattern formed by the receive antenna elements 51056 through phase amounts being controlled, the phase amounts being given by the reception variable phase shifters 51058 to the signals received by the receive antenna elements 51056. The reception variable phase shifters 51058 can be controlled by the reception beam control unit 51045 described later. For example, the reception variable phase shifter 51058 can control the phase of the input signal such that the main beam is directed to a direction of the terminal apparatus 5002A transmitting the uplink signal. At this time, the phase amount given by the reception variable phase shifter 51058 can be determined similar to the phase amount given to the input signal by the transmission variable phase shifter 51053.

The antenna 5105 according to the present embodiment can divide the receive antenna elements 51056 into multiple antenna group, similar to the transmit antenna elements 51055. For example, the antenna 5105 can group the receive antenna elements 51056-1 to 51056-N/2 into an antenna group 51056A, and the receive antenna elements 51056-N/2+1 to 51056-N into an antenna group 51056B. Then, the reception beam control unit 51045 can control phase amounts given to the input signals by the reception variable phase shifters 51058 belonging to the antenna group 51056A to direct the main beam to the terminal apparatus 5002A transmitting the uplink signal. Further, the reception beam control unit 51045 can control phase amounts given to the input signals by the reception variable phase shifters 51058 belonging to the antenna group 51056B to direct the main beam to the terminal apparatus 5002B transmitting the uplink signal.

The base station apparatus 5001A according to the present embodiment has a function to demodulate the reception signals even in a case that at least some of the uplink signals of the terminal apparatus 5002A and uplink signals of the terminal apparatus 5002B are mapped on the same radio resource, details of which are described later. At this time, the antenna 5105 according to the present embodiment can direct the reception beams to both the terminal apparatus 5002A and the terminal apparatus 5002B by the above described method.

The antenna 5105 according to one present embodiment has one compositor 51059, and of course, the number of outputs the antenna 5105 is also one. Therefore, in the present embodiment, the number of antenna groups is configured to exceed the number of outputs of the antenna 5105. To be more specific, in the base station apparatus 5001A according to the present embodiment, the number of outputs of the antenna 5105 is lower than the number of main beams formed by the antenna 5105,

As described in the previous description, the number of outputs of the antenna 5105 is also associated with the number of ADCs included in the reception unit 5104, and the base station apparatus 5001A according to the present embodiment can form the antenna directivity pattern including the main beams the number of which is more than the number of ADCs. Hereinafter, a system including at least one of the ADC, the quadrature detector 51050, and the compositor 51059 is also referred to as an RI system. The base station apparatus 5001A according to the present embodiment can direct M main beams to M terminal apparatuses for which the uplink signals are non-orthogonally multiplexed. Needless to say, the base station apparatus 5001A according to the present embodiment can also direct M main beams to M terminal apparatuses for which the uplink signals are orthogonally multiplexed.

In accordance with the control signal input from the control unit 5102, the reception unit 5104 demultiplexes, demodulates, and decodes the reception signal received from the terminal apparatus 5002A through the antenna 5105, and outputs information resulting from the decoding to the higher layer processing unit 5101.

The reception beam control unit 51045 controls the reception variable phase shifters 51058 in the antenna 5105 to control the antenna directivity pattern of the antenna 5105. The reception beam control unit 51045 can acquire information for controlling the antenna directivity pattern, similar to the transmission beam control unit 51036 previously described.

The radio reception unit 51041 controls the amplification level in such a manner as to suitably maintain a signal level of an uplink signal received through the antenna 5105, and thereafter, performs orthogonal demodulation, based on an in-phase component and an orthogonal component of the received signal, and converts the resulting orthogonally-demodulated analog signal into a digital signal.

The radio reception unit 51041 removes a portion corresponding to CP from the digital signal resulting from the conversion. The radio reception unit 51041 performs Fast Fourier Transform (FFT) on the signal from which CP has been removed, extracts a signal in the frequency domain, and outputs the resulting signal to the demultiplexing unit 51042.

The demultiplexing unit 51042 demultiplexes the signal input from the radio reception unit 51041 into PUCCH, PUSCH, and the signal such as the uplink reference signal. The demultiplexing is performed based on radio resource allocation information that is determined in advance by the base station apparatus 5001A using the radio resource control unit 51011 and that is included in the uplink grant notified to each of the terminal apparatuses 5002.

Furthermore, the demultiplexing unit 51042 makes a compensation of channels including PUCCH and PUSCH. The demultiplexing unit 51042 demultiplexes the uplink reference signal.

The demodulation unit 51043 performs Inverse Discrete Fourier Transform (IDFT) on PUSCH, acquires modulation symbols, and performs reception signal demodulation, that is, demodulates each of the modulation symbols of PUCCH and PUSCH, in compliance with the modulation scheme prescribed in advance, such as BPSK, QPSK, 16QAM, 64QAM, 256QAM, or the like, or in compliance with the modulation scheme that the base station apparatus 5001A itself notified in advance, with the uplink grant, each of the terminal apparatuses 5002.

In demodulating the non-orthogonal multiplexed signals, in which the uplink signals of multiple terminal apparatuses (e.g., the uplink signals of the terminal apparatus 5002A and terminal apparatus 5002B) are non-orthogonally multiplexed, to obtain an uplink signal of a certain terminal apparatus (e.g., the terminal apparatus 5002A), the demodulation unit 51043 can consider the uplink signal of another terminal apparatus (e.g., the terminal apparatus 5002B) as an interference signal to perform demodulation processing for removing or preventing the interference signal. In this instance, to remove or prevent the interference signal, the demodulation unit 51043 can also use Symbol Level Interference Cancellation (SLIC) configured to cancel the interference based on a demodulation result of the interference signal, Codeword Level Interference Cancellation (CWIC) configured to cancel the interference based on a decoding result of the interference signal, Maximum Likelihood Detection (MLD) configured to search for the most likely signal to be transmitted among the transmission signal candidates, or the like.

The decoding unit 51044 decodes the coded bits of PUCCH and PUSCH, which have been demodulated, at the coding rate in compliance with a coding scheme prescribed in advance, the coding rate being prescribed in advance or being notified in advance with the uplink grant to the terminal apparatus 2 by the base station apparatus 5001A itself, and outputs the decoded uplink data and uplink control information to the higher layer processing unit 5101. In a case that MISCH is re-transmitted, the decoding unit 51044 performs the decoding with the coded bits input from the higher layer processing unit 5101 and retained in an HARQ buffer, and the demodulated coded bits.

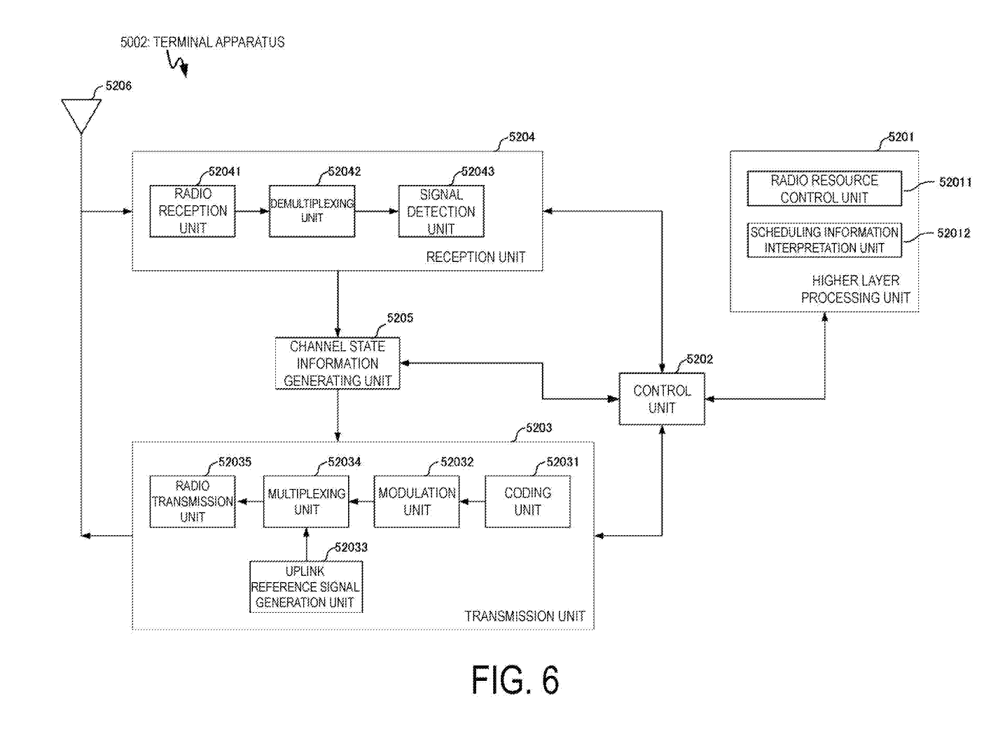

FIG. 6 is a schematic block diagram illustrating a configuration of the terminal apparatuses 5002 (that is, the terminal apparatus 5002A and the terminal apparatus 5002B) according to the present embodiment. As illustrated in FIG. 6, the terminal apparatus 5002A is configured, including a higher layer processing unit (higher layer processing step) 5201, a control unit (controlling step) 5202, a transmission unit (transmitting step) 5203, a reception unit (receiving step) 5204, a channel state information generating unit (channel state information generating step) 5205, and an antenna 5206. The higher layer processing unit 5201 is configured, including a radio resource control unit (radio resource controlling stop) 52011 and a scheduling information interpretation unit (scheduling information interpreting step) 52012. The transmission unit 5203 is configured, including a coding unit (coding step) 52031, a modulation unit (modulating step) 52032, an uplink reference signal generation unit (uplink reference signal generating step) 52033, a multiplexing unit (multiplexing step) 52034, and a radio transmission unit (radio transmitting step) 52035. The reception unit 5204 is configured, including a radio reception unit (radio receiving step) 52041, a demultiplexing unit (demultiplexing step) 52042, a signal detection unit (signal detecting step) 52043, and a reception beam control unit (reception beam controlling step) 51045.

The higher layer processing unit 5201 outputs the uplink data (the transport block) generated by a user operation or the like, to the transmission unit 5203. The higher layer processing unit 5201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 5201 outputs, to the transmission unit 5203, information indicating a terminal apparatus function supported by each terminal apparatus 5002 itself.

The radio resource control unit 52011 manages various configuration information on each terminal apparatus 5002 itself. The radio resource control unit 52011 generates information to he mapped to each uplink channel, and outputs the generated information to the transmission unit 5203.

The radio resource control unit 52011 acquires configuration information on CSI feedback transmitted from the base station apparatus, and outputs the acquired information to the control unit 5202.

The scheduling information interpretation unit 52012 interprets the Downlink Control Information received through the reception unit 5204, and determines scheduling information. The scheduling information interpretation unit 52012 generates the control information in order to control the reception unit 5204 and the transmission unit 5203 in accordance with the scheduling information, and outputs the generated information to the control unit 5202.

Based on the information input from the higher layer processing unit 5201, the control unit 5202 generates a control signal for controlling the reception unit 5204, the channel state information generating unit 5205, and the transmission unit 5203. The control unit 5202 outputs the generated control signal to the reception unit 5204, the channel state information generating unit 5205, and the transmission unit 5203 to control the reception unit 5204 and the transmission unit 5203.

The control unit 5202 controls the transmission unit 5203 to transmit CSI generated by the channel state information generating unit 5205 to the base station apparatus.

In accordance with the control signal input from the control unit 5202, the reception unit 5204 demultiplexes, demodulates, and decodes a reception signal received from the base station apparatuses 5001A through the antenna 5206, and outputs the information resulting from the decoding to the higher layer processing unit 5201.

The radio reception unit 52041 converts, by down-converting, a downlink signal received through the antenna 5206 into a baseband signal, removes unnecessary frequency components, controls an amplification level in such a manner as to suitably maintain a signal level, performs orthogonal demodulation based on an in-phase component and an orthogonal component of the received signal, and converts the resulting orthogonally-demodulated analog signal into a digital signal.

The radio reception unit 52041 removes a portion corresponding to CP from the digital signal resulting from the conversion, performs fast Fourier transform on the signal from which CP has been removed, and extracts a signal in the frequency domain.

The demultiplexing unit 52042 demultiplexes the extracted signal into PHICH, PDCCH, EPDCCH, PDSCH, and the downlink reference signal. Further, the demultiplexing unit 52042 makes a compensation of channels including PHICH, PDCCH, and EPDCCH based on a channel estimation value of the desired signal obtained from the channel measurement, detects the downlink control information, and outputs the information to the control unit 5202. The control unit 5202 outputs PDSCH and the channel estimation value of the desired signal to the signal detection unit 52043.

The signal detection unit 52043, using PDSCH and the channel estimation value, detects a signal, and outputs the detected signal to the higher layer processing unit 5201.

The transmission unit 5203 generates the uplink reference signal in accordance with the control signal input from the control unit 5202, codes and modulates the uplink data (the transport block) input from the higher layer processing unit 5201, multiplexes PUCCH, PUSCH, and the generated uplink reference signal, and transmits a result of the multiplexing to the base station apparatus 5001A through the antenna 5206.

The coding unit 52031 codes the uplink control information input from the higher layer processing unit 5201 in compliance with a coding scheme, such as convolutional coding or block coding. Furthermore, the coding unit 52031 performs turbo coding in accordance with information used for the scheduling of PUSCH.

The modulation unit 52032 modulates coded bits input from the coding unit 52031, in compliance with the modulation scheme notified with the Downlink Control information, such as BPSK, QPSK, 16QAM, or 64QAM, or in compliance with a modulation scheme prescribed in advance for each channel.

The uplink reference signal generation unit 52033 generates a sequence acquired according to a rule (formula) prescribed in advance, based on a physical cell identity (PCI, also referred to as a Cell ID or the like) for identifying the base station apparatus 5001A, a bandwidth in which the uplink reference signal is arranged, a cyclic shift notified with the uplink grant, a parameter value for generation of a DMRS sequence, and the like.

In accordance with the control signal input from the control unit 5202, the multiplexing unit 52034 rearranges modulation symbols of PUSCH in parallel and then performs Discrete Fourier Transform (DFT) on the rearranged modulation symbols. Furthermore, the multiplexing unit 52034 multiplexes PUCCH and PUSCH signals and the generated uplink reference signal for each transmit antenna port. To be more specific, the multiplexing unit 52034 arranges the PUCCH and PUSCH signals and the generated uplink reference signal in the resource elements for each transmit antenna port.

The radio transmission unit 52035 performs Inverse Fast Fourier Transform (IFFT) on a signal resulting from the multiplexing, performs the modulation of SC-FDMA scheme, generates an SC-FDMA symbol, attaches CP to the generated SC-FDMA symbol, generates a baseband digital signal, converts the baseband digital signal into an analog signal, removes unnecessary frequency components, up-converts a result of the removal into a signal of a carrier frequency, performs power amplification, and outputs a final result to the transmit and/or receive antenna 5206 for transmission.

The signal detection unit 52043 according to the present embodiment can perform the demodulation processing, based on information on conditions of multiplex of a transmission signal addressed to the terminal apparatus itself and information on conditions of retransmission of a transmission signal addressed to the terminal apparatus itself.

Regarding the non-orthogonal multiplexed signals in which the transmission signal addressed to the terminal apparatus itself is non-orthogonally multiplexed by a transmission signal addressed to another terminal apparatus (e.g., the terminal apparatus 5002B), the signal detection unit 52043 can consider the signal addressed to another terminal apparatus as an interference signal to perform the demodulation processing for removing or preventing the interference signal. At this instance, the signal detection unit 52043 can also use SLIC, CWIC, maximum likelihood detection, or the like in order to remove or prevent the interference signal.

The signal detection unit 52043 can also acquire a RV notified by the base station apparatus 5001A as the information on conditions of retransmission of the transmission signal addressed to the terminal apparatus itself. In a case that the RV indicates a RV including the most systematic bits, the signal detection unit 52043 can interpret the transmission signal addressed to the terminal apparatus itself as being non-orthogonally multiplexed by a signal addressed to another terminal apparatus transmission to perform the demodulation processing.

The signal detection unit 52043 can also acquire information indicating a transmit mode notified by the base station apparatus 5001A as the information on conditions of multiplex of the transmission signal addressed to the terminal apparatus itself. For example, in a case that the information indicating the transmit mode indicates a prescribed transmit mode, the signal detection unit 52043 can perform the demodulation processing based on the information on conditions of retransmission of the transmission signal addressed to the terminal apparatus itself described above. Here, a prescribed mode is a transmit mode enabling the terminal apparatus 5002A to receive the non-orthogonal multiplexed signals in which the transmission signal addressed to the terminal apparatus itself is non-orthogonally multiplexed by the transmission signal addressed to another terminal apparatus. The terminal apparatus 5002A can acquire the information on conditions of multiplex of the transmission signal addressed to the terminal apparatus itself, based on, for example, information notified by the higher layer such as RRC signaling.

Only in a case that the information on conditions of multiplex of the transmission signal addressed to the terminal apparatus itself and the information on conditions of retransmission of the transmission signal addressed to the terminal apparatus itself indicate the respective prescribed conditions, the signal detection unit 52043 can interpret the transmission signal addressed to the terminal apparatus itself as being non-orthogonally multiplexed by the transmission signal addressed to another terminal apparatus to perform the demodulation processing. For example, in a case that the information indicating the transmit mode notified to the signal detection unit 52043 indicates a prescribed transmit mode (e.g., a transmit mode enabling the terminal apparatus 5002A to receive the non-orthogonal multiplexed signal), and the information on conditions of retransmission of the transmission signal addressed to the terminal apparatus itself indicates that the transmission signal is an initial transmission signal (e.g., NDI indicates ‘1’), the signal detection 52043 can interpret the transmission signal addressed to the terminal apparatus itself as being non-orthogonally multiplexed by the transmission signal addressed to another terminal apparatus to perform the demodulation processing.

According to the base station apparatus 5001A, the terminal apparatus 5002A, and the terminal apparatus 5002B described above, the base station apparatus 5001A can, when transmitting the signal in which the transmission signal addressed to the terminal apparatus 5002A and the transmission signal addressed to the terminal apparatus 5002B are non-orthogonally multiplexed, set the number of at least some of RE systems to be less than the number of the non-orthogonal multiplexed signals, and perform the transmission with the transmission beams being directed to the respective terminal apparatuses (that is, the terminal apparatus 5002A and the terminal apparatus 5002B) for which the signals included in the non-orthogonally multiplexed signals are destined. At the same time, even in a case of receiving the signals transmitted in which at least some of the uplink signals of multiple terminal apparatuses are on the same resource, the base station apparatus 5001A can set the number of at least some of RF systems to be less than the number of terminal apparatuses while performing the reception with the reception beams being directed to the respective terminal apparatuses. Therefore, the base station apparatus 5001A can improve efficiencies of downlink non-orthogonal access and uplink non-orthogonal access, contributing to improvement of the frequency efficiency of the communication system.

### 1.2. Modification Example 1

The present modification example deals with a case that the configuration of the antenna 5105 is different.

In the present modification example, the configuration of the antenna 5105 is not limited to a phased array antenna configuration. For example, a configuration of a surface scattering antenna as disclosed in Japanese patent application publication No. 2013-539949 may be included in the present modification example. Further, the surface scattering antenna may include metamaterial elements.

The surface scattering antenna includes adjustable scattering elements having electromagnetic properties that are adjustable in response to external inputs. In the present modification example, the transmission beam control unit 51036 and the reception beam control unit 51045 have a function to generate external input information adjusting the scattering elements.

The surface scattering antenna can form a specific antenna directivity pattern by adjusting the scattering elements in response to the external inputs. The antenna 5105 can form multiple antenna directivity patterns. The transmission beam control unit 51036 and the reception beam control unit 51045 grasp the external input information forming the multiple antenna directivity patterns. For example, the transmission beam control unit 51036 can generate the external input information capable of forming the antenna directivity pattern in which the beam is directed to both the terminal apparatus 5002A and the terminal apparatus 5002B, and input the generated information as the external inputs to the antenna 5105. By controlling in this way, the base station apparatus 5001A in the present modification example can transmit the non-orthogonal multiplexed signals in which at least some of the downlink signal addressed to the terminal apparatus 5002A and the downlink signal addressed to the terminal apparatus 5002B are mapped on the same radio resource by way of beam forming transmission which directs the beams to both the terminal apparatus 5002A and the terminal apparatus 5002B.

In the surface scattering antenna in this modification, liquid crystal can be included in the metamaterial element. The surface scattering antenna in the present modification example can be defined as a liquid crystal antenna.

In the method according to the first embodiment, the base station apparatus 5001A can adjust the gains of the main beams included in the antenna directivity pattern formed by the antenna 5105 by controlling the number of transmit antenna elements 51055 or receive antenna elements 51056 constituting the antenna group. The method according to the present modification example can also adjust the gains of the main beams by controlling the scattering elements, and therefore, the base station apparatus 5001A can provide a gain difference between the multiple main beams included in the antenna directivity pattern generated by the antenna 5105.

The antenna 5105 in the present modification example can control the half-value width of the main beam to be formed, similar to the first embodiment. The antenna 5105 in the present modification example can adjust the half-value width of the main beam by controlling the scattering elements, and therefore, can control the half-value width of the main beam depending on the moving speed of the terminal apparatus 5002 or the like, for example.

### 2. Second Embodiment

The base station apparatus 5001A according to the present embodiment communicates with the terminal apparatus 5002A. The configurations of the base station apparatus 5001A and terminal apparatus 5002A according to the present embodiment are the same as those in the first embodiment. Hereinafter, a method according to the present embodiment is described focusing on points different from the first embodiment.

The downlink signal transmitted from the base station apparatus 5001A arrives the terminal apparatus 5002A via not only a direct wave (direct path, direct arrival path) but also a reflected wave (reflection path, delay path). To he more specific, there are multiple paths between the base station apparatus 5001A and the terminal apparatus 5002A,

The base station apparatus 5001A according to the present embodiment can direct multiple main beams to the terminal apparatus 5002A. Moreover, the base station apparatus 5001A can direct the multiple main beams to the multiple paths. By controlling in this way, even in a case that there is an object blocking the direct wave between the base station apparatus 5001A and the terminal apparatus 5002A, the base station apparatus 5001A can use another path (e.g., the reflected wave) to continuously communicate with the terminal apparatus 5002A.

The transmission beam control unit 51036 and reception beam control unit 51045 according to the present embodiment can acquire information indicating output angle information and arrival angle information on elementary waves (electrical waves, planar waves) constituting the multiple paths Then, the transmission beam control unit 51036 and the reception beam control unit 51045 can control the transmission variable phase shifters 51053 and reception variable phase shifters 51058 included in multiple antenna groups in the antenna 5105 to direct the main beams formed by the respective antenna groups to output directions and arrival directions of the different paths.

The transmission beam control unit 51036 according to the present embodiment can control the antenna directivity pattern such that the antenna 5105 directs the main beam to a path larger in a receive power for the terminal apparatus 5002A among multiple paths grasped by the base station apparatus 5001A. Of course, the reception beam control unit 51045 can also perform the similar control.

The antenna 5105 according to the present embodiment can provide a gain difference between multiple main beams, similar to the antenna 5105 according to the first embodiment. For example, the transmission beam control unit 51036 can set the gain of the main beam directed to a path larger in a receive power for the terminal apparatus 5002A among multiple paths grasped by the base station apparatus 5001A to a value larger than the gains of other main beams. By controlling in this way, the base station apparatus 5001A can perform communication of a high capacity (high throughput, high channel capacity) with the terminal apparatus 5002A. The transmission beam control unit 51036 can set the gain of the main beam directed to a path smaller in a receive power for the terminal apparatus 5002A among multiple paths grasped by the base station apparatus 5001A to a value larger than the gains of other main beams. By controlling in this way, the base station apparatus 5001A can perform communication of high reliability with the terminal apparatus 5002A.

The transmission beam control unit 51036 can control the half-value widths of multiple main beams formed by the antenna 5105, similar to the first embodiment. The transmission beam control unit 51036 can widen the half-value width of the main beam directed to the terminal apparatus 5002 higher in the moving speed, for example.

As in the method described above, the base station apparatus 5001A according to the present embodiment can direct the main beams included in the antenna directivity pattern formed by the antenna 5105 to multiple paths, and control the half-value widths of the respective main beams. This can be said that the base station apparatus 5001A according to the present embodiment can control channel delay spread (channel profile, delay profile) between the base station apparatus 5001A and the terminal apparatus 5002A. For example, in a case that the base station apparatus 5001A directs the main beam of the antenna 5105 only to the direct path when transmitting the downlink signal of the terminal apparatus 5002A, a delay spread observed by the terminal apparatus 5002A is smaller. On the other hand, in a case that the base station apparatus 5001.A directs the main beam of the antenna 5105 not only to the direct path but also to the delay path when transmitting the downlink signal of the terminal apparatus 5002A, a delay spread observed by the terminal apparatus 5002A is larger. Therefore, the base station apparatus 5001A according to the present embodiment can control a radio parameter associated with the channel delay spread depending on the antenna directivity pattern formed by the antenna 5105. Here, the radio parameter associated with the channel delay spread includes a symbol length, a guard interval length, a cyclic prefix length, and a modulation scheme. For example, in the case that the base station apparatus 5001A directs the main beam of the antenna 5105 only to the direct path, the base station apparatus 5001A can use a shorter guard interval length. On the other hand, in the case that the base station apparatus 5001A directs the main beam of the antenna 5105 also to the delay path, besides the direct path, the base station apparatus 5001A can use a longer guard interval length. The control unit 5102 can control the radio parameter associated with the channel delay spread based on information controlling the antenna directivity pattern formed by the antenna 5105 or the antenna directivity pattern of the antenna 5105 generated by the transmission beam control unit 51036.

According to the base station apparatus 5001A in the present embodiment described above, the base station apparatus 5001A can direct the main beams included in the antenna directivity pattern formed by the antenna 5105 to the paths the number of which is more than the number of RF systems provided to the base station apparatus 5001A itself, which allows communication quality to be improved, and thus, contributes to improvement of the frequency efficiency of the communication system.

### 3. Description Common to All Embodiments

A program running on each of the base station apparatus and the terminal apparatus according to an aspect of the present invention is a program (a program for causing a computer to operate) that controls a CPU and the like in such a manner as to realize the functions according to an aspect of the above-described embodiments of the present invention. The information handled by these apparatuses is temporarily held in a RAM at the time of processing, and is then stored in various types of ROMs, HDDs, and the like, and read out by the CPU as necessary to be edited and written. Here, a semiconductor medium (a ROM, a non-volatile memory card, or the like, for example), an optical recording medium (DVD, MO, MD, CD, BD, or the like, for example), a magnetic recording medium (a magnetic tape, a flexible disk, or the like, for example), and the like can be given as examples of recording media for storing the programs. In addition to realizing the functions of the above-described embodiments by performing loaded programs, functions according to an aspect of the present invention can be realized by the programs running cooperatively with an operating system, other application programs, or the like in accordance with instructions included in those programs,

In a case that delivering these programs to market, the programs can be stored in a portable recording medium, or transferred to a server computer connected via a network such as the Internet. In this case, storage devices in the server computer are also included in an aspect of the present invention. Furthermore, some or all portions of each of the terminal apparatus and the base station apparatus in the above-described embodiments may be realized as LSI, which is a typical integrated circuit. The functional blocks of the reception device may be individually realized as chips, or may be partially or completely integrated into a chip. In a case that the functional blocks are integrated into a chip, an integrated circuit control unit for controlling them is added.

The circuit integration technique is not limited to LSI, and the integrated circuits for the functional blocks may be realized as dedicated circuits or a multi-purpose processor. Furthermore, in a case that with advances in semiconductor technology, a circuit integration technology with which an LSI is replaced appears, it is also possible to use an integrated circuit based on the technology.

Note that the invention of the present patent application is not limited to the above-described embodiments. The terminal apparatus according to the invention of the present patent application is not limited to the application in the mobile station device, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

The embodiments of the invention have been described in detail thus far with reference to the drawings, but the specific configuration is not limited to the embodiments. Other designs and the like that do not depart from the essential spirit of the invention also fall within the scope of the claims.

### INDUSTRIAL APPLICABILITY

The present invention can be preferably used in a base station apparatus, and a communication method.

The present international application claims priority based on JP 2015-235636 filed on Dec. 2, 2015, and all the contents of JP 2015-235636 are incorporated in the present international application by reference.

### DESCRIPTION OF REFERENCE NUMERALS

5001A Base station apparatus
5002, 5002A, 5002B Terminal apparatus
5101 Higher layer processing unit
51011 Radio resource control unit
51012 Scheduling unit
5102 Control unit
5103 Transmission unit
51031 Coding unit
51032 Modulation unit
51033 Downlink reference signal generation unit
51034 Multiplexing unit
51035 Radio transmission unit
51036 Transmission beam control unit
5104 Reception unit
51041 Radio reception unit
51042 Demultiplexing unit
51043 Demodulation unit
51044 Decoding unit
51045 Reception beam control unit
5105 Antenna
51051 Quadrature modulator
51052 Distributor
51053, 51053-1 to 51053-N Transmission variable phase shifter
51054, 51054-1 to 51054-N Amplifier
51055, 51055-1 to 51055-N Transmit antenna element
51056, 51056-1 to 51056-N Receive antenna element
51057, 51057-1 to 51057-N Low noise amplifier
51058, 51058-1 to 51058-N Reception variable phase shifter
51059 Compositor
51050 Quadrature detector
5201 Higher layer processing unit
5202 Control unit
5203 Transmission unit
5204 Reception unit
5205 Channel state information generating unit
5206 Antenna
52011 Radio resource control unit
52012 Scheduling information interpretation unit
52031 Coding unit
52032 Modulation unit
52033 Uplink reference signal generation unit
52034 Multiplexing unit
52035 Radio transmission unit
52041 Radio reception unit
52042 Demultiplexing unit
52043 Signal detection unit

1. A communication apparatus for communicating with multiple terminal apparatuses, the communication apparatus comprising:
a transmission unit configured to generate non-orthogonal multiplexed signals in which at least some of downlink signals addressed to the multiple terminal apparatuses are mapped on the same radio resource;
an antenna capable of forming an antenna directivity pattern including multiple main beams; and
a transmission beam control unit configured to generate a signal controlling he antenna directivity pattern, wherein
the non-orthogonal multiplexed signals are simultaneously transmitted by use of the multiple main beams, and
the number of main beams included in the antenna directivity pattern is more than the number of RF systems of the antenna.

2. The communication apparatus according to claim 1, wherein the antenna sets gains of the multiple main beams to values different from each other.

3. The communication apparatus according to claim 1, wherein the antenna sets half-value widths of the multiple main beams to values different from each other.

4. The communication apparatus according to claim 1, wherein the transmission unit generates multiple reference signals to be transmitted in antenna directivity patterns different from each other via the antenna.

5. The communication apparatus according to claim 1, wherein the transmission beam control unit acquires information controlling the antenna directivity pattern.

6. The communication apparatus according to claim 2, wherein the transmission unit notifies at least one of the multiple terminal apparatuses of the information associated with the gains of the multiple main beams.

7. The communication apparatus according to claim 1, wherein the antenna is a surface scattering antenna including metamaterial elements.

8. A communication apparatus for communicating with multiple terminal apparatuses, the communication apparatus comprising;
an antenna capable of forming an antenna directivity pattern including multiple main beams;
a reception beam control unit configured to generate a signal controlling the antenna directivity pattern; and
a reception unit configured to demodulate signals received in which signals at least some of uplink signals transmitted by the multiple terminal apparatuses are non-orthogonally multiplexed on the same radio resource, wherein
at least some of the uplink signals transmitted by the multiple terminal apparatuses included in the signals non-orthogonal multiplexed and received are simultaneously received by use of the multiple main beams different from each other, and
the number of main beams included in the antenna directivity pattern is more than the number of RF systems of the antenna.

9. (canceled)

10. (canceled)

11. A communication method of a communication apparatus for communicating with multiple terminal apparatuses, the communication method comprising the steps of:
generating non-orthogonal multiplexed signals in which at least some of downlink signals addressed to the multiple terminal apparatuses are mapped on the same radio resource;
forming an antenna directivity pattern including multiple main beams;
generating a signal controlling the antenna directivity pattern; and
simultaneously transmitting the non-orthogonal multiplexed signals by use of the multiple main beams, wherein
the number of main beams included in the antenna directivity pattern is more than the number of RF systems of the antenna.

12. The communication apparatus according to claim 2, wherein the transmission unit generates multiple reference signals to be transmitted in antenna directivity patterns different from each other via the antenna.

13. The communication apparatus according to claim 2, wherein the transmission beam control unit acquires information controlling the antenna directivity pattern.
